(19) United States
(12) Patent Application Publication
(10) Pub. No.: US 2024/0246658 A1
(43) Pub. Date: Jul. 25, 2024

(54) POWER SYSTEM FOR AN AIRCRAFT AND METHOD

(71) Applicant: Rolls-Royce Deutschland Ltd & Co KG, Blankenfelde-Mahlow (DE)

(72) Inventors: Patrick Martin, Indianapolis, IN (US); Erik Munevar, Indianapolis, IN (US)

(21) Appl. No.: 18/101,509

(22) Filed: Jan. 25, 2023

(51) Int. Cl. B64C 13/16; B64D 31/06

(52) U.S. Cl. CPC B64C 13/16; B64D 31/06; B64D 2221/00

(57) ABSTRACT

A power system for an aircraft includes at least one power distribution unit. The at least one power distribution unit includes at least one input configured to receive electrical power from at least one energy source, and at least one output configured to provide electrical power from the at least one input to at least one electrical load. The at least one power distribution unit also includes a control system configured to detect a condition, and to perform an action based on the detected condition.

### BACKGROUND

The present disclosure relates to a power system for an aircraft and to a method.

Aircrafts are powered in many different ways. Internal combustion engines (e.g., piston engines or gas turbine engines) enable long ranges and high speeds. Propulsion systems with one or more electric motors enable the use of sustainably generated energy and are often particularly quiet and only require little maintenance compared to, for example, combustion engines.

An important aspect is the reliability of the systems of an aircraft. In the case of electrically driven aircrafts, a reliable power distribution from an energy source to electric motors is important. There is a general need for a precise monitoring of the status of the electric power distribution and for a quick fault detection. Examples for possible faults are an electric short between an electrical winding of an electric motor and a frame of the aircraft, a lane-to-lane short, an insulation failure, an out-of-range current, a too high or too low input voltage and so forth.

Depending on the type of failure, different corrective actions are possible. For example, a circuit or a device having a short may be isolated. Further, an emergency landing or other measures may be initiated.

In case of a fault, it is generally desirable to initiate a reaction in a quick manner. In addition, a reliable operation of the power distribution is generally aimed for.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a power system for an aircraft is improved.

According to an aspect, a power system for an aircraft is provided. The power system includes at least one power distribution unit. The at least one power distribution unit includes at least one input configured to receive electrical power from at least one energy source, at least one output configured to provide electrical power from the at least one input to at least one electrical load (e.g., at least one inductive electrical load, such as at least one electric machine), and a control system configured to detect a condition and to perform an action based on the detected condition.

This is based on the finding that in current solutions known, multiple communication interfaces are involved in communicating statuses of sub-system components to a supervisory control such as a flight control system, where the supervisory control decides on actions for operating conditions or faults. Such multiple communication interfaces may create multiple potential points of failure. In addition, such a communication is found to potentially add delays in the communication and decision process. According to the present disclosure, the power distribution unit includes a control system that may directly detect and react on conditions (e.g., failure events). By this, the number of communication nodes and potential failure points may strongly be decreased. Upon first sight, this may appear counter-intuitive, because the addition of a control system capable of detecting and reacting states and failures may increase the complexity of the power distribution unit. However, the possible reduction of the number of communication connections may strongly outweigh this increased unit complexity.

According to embodiments, the power supply may include one or more (e.g., all) of the following features. The condition may be or result from a failure event, and the action may be a corrective action. The at least one power distribution unit may include a plurality of outputs. Each output of the plurality of outputs may be configured to provide electrical power from the at least one input to one or more respective electrical loads (e.g., one or more electric machines). The power system may include a plurality of power distribution units (e.g., each of which is configured as described above). The power system may include the at least one electrical machine, and the at least one electrical machine may have a plurality of electrical lanes. Each electrical lane of the plurality of electrical lanes may be provided with electrical power by a respective one of the plurality of power distribution units. The power system may include the at least one electrical machine and at least one rotor unit having rotor blades and being driven by the at least one electrical machine. The power system may include a plurality of electrical loads (e.g., electric machines), where each electrical load of the plurality of electrical loads (e.g., electric machines) is provided with electrical power via the at least one power distribution unit. The at least one power distribution unit may include a communication interface and may be configured to communicate an information indicating the condition via the communication interface. The communication interface may be a unidirectional communication interface. The power system may include a flight control system that may be communicatively connected to the communication interface of the at least one power distribution unit, where the flight control system may be configured to control the at least one electrical load (e.g., electric machine). The flight control system may be configured to perform an action in response to the reception of the information indicating the condition. The action may include performing a flight maneuver in dependence on the information indicating the condition. The control system may be coupled with a sensor configured to sense an electrical, mechanical, or thermal parameter, where the control system may be configured to detect the condition based on the sensed electrical, mechanical, or thermal parameter. The electrical parameter may be a current, a voltage, a resistance, an impedance, an inductance, or a capacity. The corrective action may include a change of the distribution of electrical power by the power distribution unit. The power system may include the at least one energy source. The at least one energy source may be an electrical battery. The at least one power distribution unit may include a fork electrically connecting the at least one input with at least two outputs. The power system may be included in an aircraft. According to an aspect, an aircraft including the power system of any embodiment described herein is provided.

According to an aspect, a method is provided. The method includes providing, by a power distribution unit, electrical power received via at least one input of the power distribution unit from at least one energy source to at least one electrical load (e.g., electric machine) via at least one output of the power distribution unit. The method also includes detecting, by a control system of the power distribution unit, a condition and performing, by the control system, an action based on the detected condition.

The method may further include communicating, by the control system, information indicating the condition, the performed action, a configuration resulting from the performed action, or any combination thereof to a flight control system. The method may further include, optionally, performing, by the flight control system, an action in response to the reception of the information indicating the condition.

### BRIEF DESCRIPTION OF THE DRAWINGS

Exemplary embodiments are now described with reference to the figures; in the figures, in schematic representations:

FIG. 1 shows an aircraft for vertical take-off and landing, having a plurality of electrically driven rotor units;

FIG. 2 shows an aircraft in the form of an airplane with a rotor unit and various energy sources;

FIG. 3 shows a system for the aircraft of FIG. 1 or 2, including power distribution units;

FIG. 4 shows one of the power distribution units according to FIG. 3;

FIG. 5 shows a method of controlling a power system of an aircraft.

### DETAILED DESCRIPTION

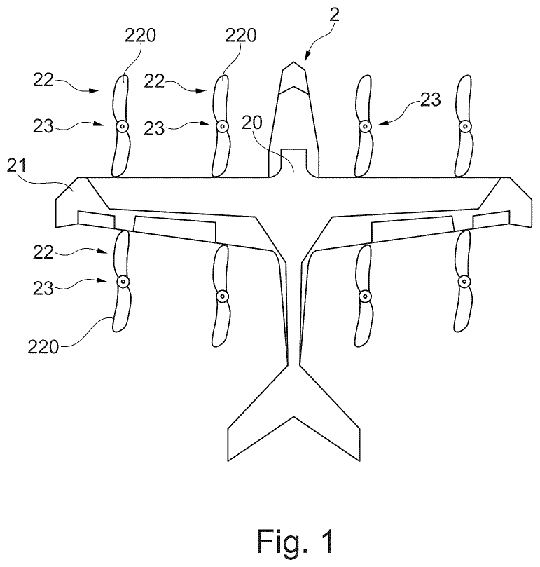

FIG. 1 shows a top view of an aircraft 2 in the form of a vertical take-off and landing (VTOL) aircraft. The aircraft 2 includes a fuselage 20, wings 21, and a plurality of electrical loads 23 (e.g., in the form of electric machines).

The electric machines 23 are mounted on the wings 21. Each of the electric machines 23 drives a rotor unit 22. Each rotor unit 22 includes rotor blades 220. In the present example, each rotor unit 22 is configured as a propeller.

The aircraft 2 has a plurality of (e.g., four) front electric machines 23 and rotor units 22. Therein, each of the front rotor units 22 or one or more of the front rotor units 22 and/or other rotor units 22 are pivoted so as to selectively provide thrust in an at least predominantly vertical direction, or in an at least predominantly horizontal direction. Further, the aircraft 2 includes a plurality of (e.g., four) rear electrical machines 23 and rotor units 22, where each of the rotor units 22 (e.g., rear rotor units) has a propeller rotational axis with a fixed orientation with respect to the fuselage 20. These rotor units 22 (e.g., rear rotor units) are oriented so as to provide thrust in at least predominantly vertical direction.

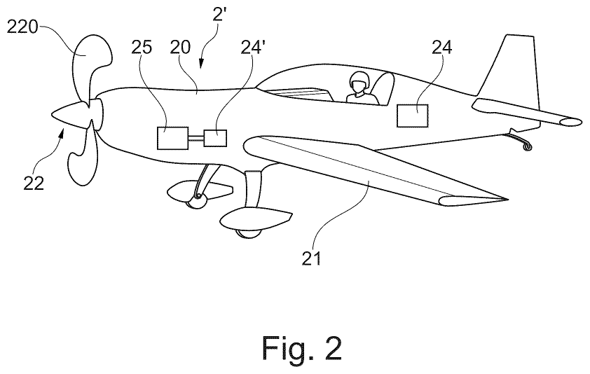

FIG. 2 shows an aircraft 2′ in the form of an airplane having a fuselage 20, wings 21, and one front rotor unit 22.

The aircraft 2′ includes an electric machine and/or an engine combusting fuel for driving the rotor unit 22. The rotor unit 22 includes a plurality of rotor blades 220 (e.g., two rotor blades 220). In the example shown, the rotor blades 220 are mounted on a hub to form a propeller. In alternative embodiments, the aircraft 2′ or the aircraft 2 of FIG. 1 includes, for example, a fan instead of a propeller and/or a plurality of propellers, fans, or the like.

As with the aircraft of FIG. 1, the aircraft 2′ further includes one or more energy sources 24, 24′. In the present example, the aircraft 2′ includes an electric battery as an energy source 24 and an electric generator 24′ as another energy source. The electric generator energy source 24′ is driven by a turbine 25 or other engine (e.g., in the form of an auxiliary power unit (APU)). Alternatively or additionally, the electric generator energy source 24′ may be driven by an engine driving the rotor unit 22.

Electric energy supplied by the electric generator energy source 24′ may be stored in the electric battery energy source 24.

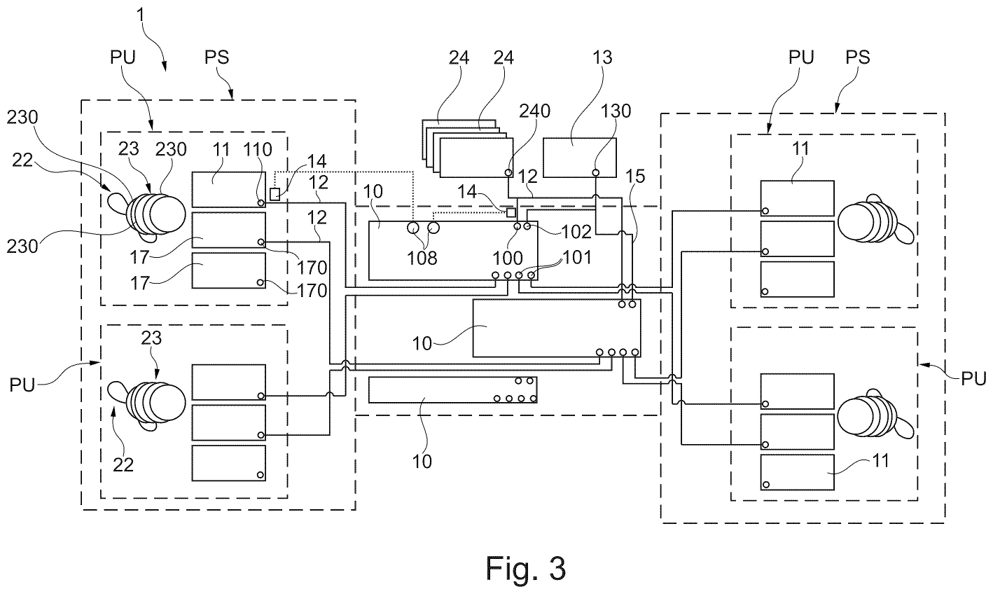

FIG. 3 shows a power system 1 of the aircraft 2 of FIG. 1, wherein only two propulsion systems PS are shown for simplicity, each of which includes two propulsion units PU with one electric machine 23 and rotor unit 22. However, the aircraft 2 of FIG. 1 may alternatively include two power systems 1, each as shown in FIG. 3. Similarly, the aircraft 2′ of FIG. 2 may include the power system 1 of FIG. 3 with just one propulsion unit PU.

The power system 1 includes generally at least one power distribution unit 10 (e.g., in this example, a plurality of power distribution units 10; three power distribution units 10). In FIG. 3, only connections of two of the power distribution units 10 are shown for the ease of illustration; however, the third power distribution unit 10 is connected in the same manner as the other two power distribution units 10. In the present example, the three power distribution units 10 are of the same design.

Each of the power distribution units 10 includes an input 100 (e.g., alternatively, more than one input) configured to receive electrical power from at least one energy source 24 (e.g., of a plurality of energy sources). In the example of FIG. 3, the energy sources 24 are electric batteries, but other energy sources may also be provided.

Each of the power distribution units 10 includes at least one output 101 (e.g., a plurality of such outputs 101) configured to provide the electrical power from the at least one input 100 to an electric machine 23. Thus, via each power distribution unit 10, electrical power is distributed from one or more energy sources 24 to one or more electrical machines 23. In the present case, the electrical machines 23 are electric motors, each of which drives a rotor unit 22.

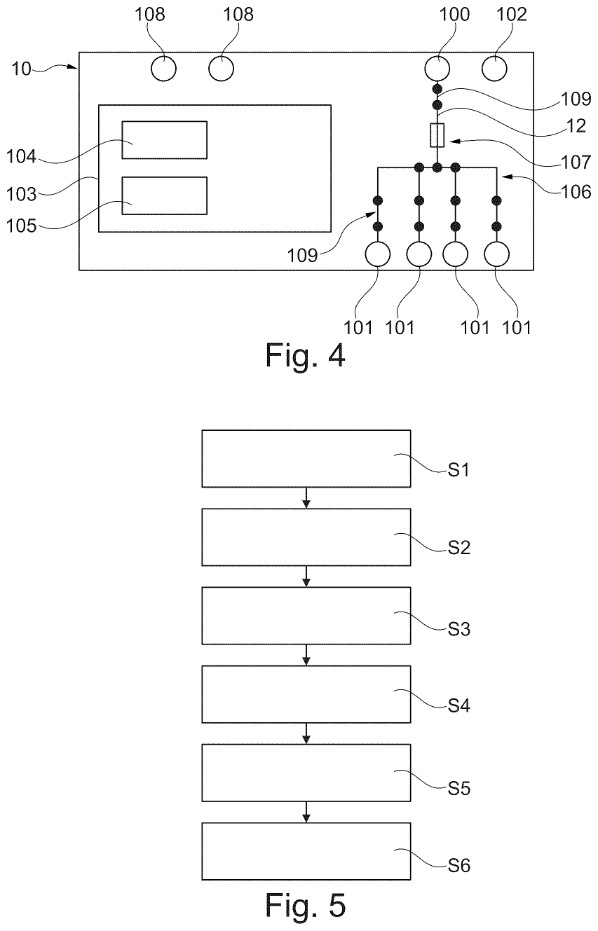

As will be described in detail below with reference to FIG. 4, each of the power distribution units 10 further includes a control system 103 configured to detect a condition (e.g., a failure event) and to perform an action (e.g., a corrective action) based on the detected condition.

As shown in FIG. 3, the power system 1 further includes power electronics units 11 for powering the electric machines 23. The power distribution units 10 receive direct current (DC) (e.g., high-voltage DC) from the power sources 24. Each of the power electronics units 11 includes one or more inverters to invert the received DC power to alternating current (AC) power. The AC power is provided to stator windings of the respective electric machine 23 to drive a rotor of the electric machine 23. For this, the input 100 of each of the power distribution units 10 is electrically connected, by a power link 12, to an output 240 of one or more of the energy sources 24. The outputs 101 of the power distribution units 10 are electrically connected, by power links 12, to an input 110 of a respective power electronics unit 11.

Each propulsion unit (PU) includes a plurality of (e.g., three) power electronics units 11.

In the present example, each electric machine 23 includes a plurality of (e.g., three) electric lanes 230. Each electric lane of the plurality of electric lanes 230 may individually drive the rotor unit 22. Thus, when one of the electric lanes 230 fails, the other electric lanes 230 of the respective electric machine 23 may still operate.

The power system 1 includes the same number of power distribution units 10 as the number of lanes 230 of the electric machines 23. Each power distribution unit 10 provides electrical power to a different lane 230 of the respective electric machines 23. Thus, each power distribution unit 10 includes an output 101 for each electric machine 23, where each electric lane 230 of one of the electric motors 23 is provided with electrical power from a different one of the power distribution units 10. In other words, a first electric lane 230 of each of the propulsion units PU and electric machines 23 is electrically connected to and supplied with power by a first one of the power distribution units 10. A second electric lane 230 of each of the propulsion units PU and electric machines 23 is electrically connected to and supplied with power by a second one of the power distribution units 10. A third electric lane 230 of each of the propulsion units PU and electric machines 23 is electrically connected to and supplied with power by a third one of the power distribution units 10.

The power system 1 further includes one or more sensors 14 (e.g., a plurality of sensors 14). One or more sensors 14 may be arranged at power links 12 to one or more of the power electronics units 11. These sensors 14 may be current sensors and configured for sensing the current to a respective power electronics unit 11. Further, a sensor 14 may be provided (e.g., at the power link 12 electrically connected to an input 100 of one of the power distribution units 10) to sense a current and/or voltage of the power provided to the respective power distribution unit 10. The sensors 14 shown in FIG. 3 and/or further sensors may be provided to sense an electrical parameter and/or a thermal parameter and/or a mechanical parameter (e.g., a current, a voltage, a resistance, an impedance, an inductance, a capacity, a temperature, a pressure, a force, a moment, a vibration, or any combination thereof). As another example, a sensor may sense a speed or the like.

Each power distribution unit 10 includes at least one sensor input 108 communicatively connected to one or more sensors 14 by a wired or wireless link. At least one of the sensors 14 may be an insulation monitoring device. At least one of the sensors 14 may be an equipment monitoring device.

Each of the power distribution units 10 includes a communication interface 102. The communication interface 102 is communicatively coupled to a communication interface 130 of a flight control system 13 by a communication link 15 (e.g., wired or wireless communication link). As an example, the power distribution units 10 are communicatively connected to one another by a communication link 15 (e.g., wired or wireless communication link; the same communication link 15).

Turning now to FIG. 4 where one of the power distribution units 10 is shown in more detail, the power distribution unit 10 includes a fork 106 of power links 12 electrically connecting the input 100 to the outputs 101. Further, the power distribution unit 10 includes one or more fuses 107 in the power links 12 electrically connecting the input 100 to the outputs 101, which may be blown by a respective overcurrent.

Further, the power distribution unit 10 includes the control system 103 mentioned above. The control system 103 includes a processor 104 and a memory 105. The processor 104 reads instructions stored in the memory 105. The control system 103 reads sensor data from the sensors 14 and determines, based on the sensor data, the operational status of the control system 103 (e.g., using one or more additional sensors inside the power distribution unit 10) and the devices connected to the control system 103. For example, the control system 103 is configured to detect a failure event (e.g., an electric short between an electrical winding of an electric machine 23 and a frame of the aircraft 2; 2′, a short from an electric lane 230 to another electric lane 230, an insulation failure, an out-of-range current, a too high or too low input voltage from the energy source(s) 24, and so forth).

The control system 103 compares the acquired sensor data, or data calculated using the sensor data, with one or more thresholds, ranges, or the like to determine the operational status of the control system 103 and the devices connected to the control system 103. The control system 103 is configured to monitor the status, condition, and potential error state of the power distribution unit 10 itself. The power distribution unit 10 is thus configured for self-monitoring.

Further, the control system 103 is configured to detect a condition and to perform an action based on the detected condition. The condition may be a failure event, and the action may be a corrective action. As an illustrative example, the power distribution unit 10 includes switches 109 in the electrical connections from the input 100 to the outputs 101. The switches 109 may be solid-state switches or mechanical switches. The corrective action may be to open one or more of the switches 109 (e.g., when the input voltage is above or below a predetermined threshold). As a further example, in case that the control system 103 determines (e.g., based on a current measurement) that the fuse 107 has been blown, the control system 103 may request an activation, or increase of power, of another electric lane 230, propulsion unit (PU), or propulsion system (PS) by communicating with at least one other power distribution unit 10. The corrective action by the power distribution unit 10 may include a change of the distribution of electrical power by the power distribution unit 10.

Upon detection of a certain condition (e.g., a failure event), the control system 103 of the power distribution unit 10 may also communicate this condition (e.g., failure event) to the flight control system 13. The flight control system 13 may then decide to perform further actions in response to the reception of the information indicating the condition (e.g., a performance and/or a change of a flight maneuver). The flight control system 13 is configured to control operation of the electric machines 23. So, the power distribution unit 10 is configured to communicate information indicating the detected condition via the communication interface 102. At least with respect to the communication with the flight control system 13, the communication interface may be a unidirectional communication interface, where the power distribution unit 10 only informs the flight control system 13 of the detected condition, which may be the result of a failure event, and does not require a response from the flight control system 13 to perform its action in response to the detection.

FIG. 5 shows a method for self-diagnosis and response in a power system such as the power system of FIG. 3. The method includes the following acts, after the occurrence of a certain condition (e.g., after occurrence of a failure event), while or after electrical power is provided by the power distribution unit 10 from the at least one energy source 24 to the at least one electric machine 23 via the at least one output 101 of the power distribution unit 10.

Act S1: Optionally, a local detection of the failure event may be performed. For example, an insulation monitoring device may detect an insulation fault. This is communicated to the corresponding power distribution device 10.

Act S2: Detecting, by the control system 103 of the power distribution unit 10, a condition (e.g., one of a set of pre-defined conditions). For this, one or more validation criteria for a pass/fail determination may be applied.

Act S3: Performing, by the control system 103 of the power distribution unit 10, an action based on the detected condition (e.g., a corrective action on a detected failure). The action leads to a new configuration of the power system 1.

Act S4: Communicating, by the control system 103 of the power distribution unit 10, an information indicating the condition and/or the performed action and/or of the new configuration of the power distribution unit 10 or the power system 1 to the flight control system 13 (or another supervisory system).

Act S5: Deciding, by the flight control system 13, on a responsive action based on the communicated information.

Act S6: Performing, by the flight control system 13, an action in response to the reception of the information indicating the condition.

Using the systems and methods described herein, the power distribution unit 10 itself takes ownership of the detection of faults and of the decision for performing corrective actions. This allows to reduce the reaction time and to increase reliability, because multiple communication connections are not necessary (e.g., from all power electronics units 11 to the flight control system 13). Further, the cybersecurity may be improved, because of the reduced number of potentially attackable communication links.

Instead of electric machines, other electrical loads may be powered by the power system.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

### LIST OF REFERENCE SIGNS

1 power system
10 power distribution unit
100 input
101 output
102 communication interface
103 control system
104 processor
105 memory
106 fork
107 fuse
108 sensor input
109 switch
11 power electronics unit
110 input
12 power link
13 flight control system
130 communication interface
14 sensor
15 communication link
2; 2′ aircraft
20 fuselage
21 wings
22 rotor unit
220 rotor blade
23 electric machine
230 lane
24; 24′ energy source
240 output
25 turbine
26 power consumer
PS propulsion system
PU propulsion unit

1. A power system for an aircraft, the power system comprising:
at least one power distribution unit comprising:
at least one input configured to receive electrical power from at least one energy source;
at least one output configured to provide electrical power from the at least one input to at least one electrical load; and
a control system configured to detect a condition and to perform an action based on the detected condition.

2. The power system of claim 1, wherein the condition is or results from a failure event, and the action is a corrective action.

3. The power system of claim 1, wherein the at least one output of the at least one power distribution unit comprises a plurality of outputs, each output of the plurality of outputs being configured to provide electrical power from the at least one input to one or more respective electrical loads of the at least one electrical load.

4. The power system of claim 1, wherein the at least one power distribution unit comprises a plurality of power distribution units.

5. The power system of claim 4, further comprising the at least one electrical load, the at least one electrical load having a plurality of electrical lanes,
wherein each electrical lane of the plurality of electrical lanes is provided with electrical power by a respective one power distribution unit of the plurality of power distribution units.

6. The power system of claim 1, further comprising the at least one electrical load in the form of at least one electric machine and at least one rotor unit, the at least one rotor unit having rotor blades and being drivable by the at least one electric machine.

7. The power system of claim 1, wherein the at least one power distribution unit comprises a communication interface and is configured to communicate information indicating the condition via the communication interface.

8. The power system of claim 7, wherein the communication interface is a unidirectional communication interface.

9. The power system of claim 7, further comprising a flight control system communicatively connected to the communication interface of the at least one power distribution unit, the flight control system being configured to control the at least one electrical load.

10. The power system of claim 9, wherein the action is a first action, and
wherein the flight control system is configured to:
receive the information indicating the condition; and
perform a second action in response to the reception of the information indicating the condition.

11. The power system of claim 10, wherein the second action comprises performance of a flight maneuver in dependence on the information indicating the condition.

12. The power system of claim 1, wherein the control system is coupled with a sensor configured to sense an electrical, mechanical, or thermal parameter, and
wherein the control system is configured to detect the condition based on the sensed electrical, mechanical, or thermal parameter.

13. The power system of claim 12, wherein the sensor is configured to sense the electrical parameter, and
wherein the electrical parameter is a current, a voltage, a resistance, an impedance, an inductance, or a capacity.

14. The power system of claim 1, wherein the action is a corrective action, the corrective action comprising a change of a distribution of electrical power by the at least one power distribution unit.

15. The power system of claim 1, further comprising the at least one energy source.

16. The power system of claim 15, wherein the at least one energy source includes an electrical battery.

17. The power system of claim 1, wherein the at least one output includes at least two outputs, and
wherein the at least one power distribution unit comprises a fork electrically connecting the at least one input with the at least two outputs.

18. The power system of claim 1, wherein the power system is comprised in an aircraft.

19. A method comprising:
providing, by a power distribution unit, electrical power received via at least one input of the power distribution unit from at least one energy source, to at least one electrical load via at least one output of the power distribution unit;
detecting, by a control system of the power distribution unit, a condition; and
performing, by the control system, an action based on the detected condition.

20. The method of claim 19, wherein the action is a first action, and
wherein the method further comprises:
communicating, by the control system, information indicating the condition, the performed first action, a configuration resulting from the performed first action, or any combination thereof to a flight control system;
receiving, by the flight control system, the information indicating the condition; and
performing, by the flight control system, a second action in response to the receiving of the information indicating the condition.
